(19) United States
(12) Patent Application Publication
(10) Pub. No.: US 2026/0205787 A1
(43) Pub. Date: Jul. 16, 2026

(54) System and Method for Secure Device Activation Using Location Information and Short-Range Communication

(71) Applicant: Airwallet ApS, Odense C. (DK)

(72) Inventors: Juri Wulff, Odense S (DK); Christian Bonde Mortensen, Odense C (DK)

(21) Appl. No.: 19/562,497

(22) Filed: Mar. 10, 2026

Related U.S. Application Data
(63) Continuation-in-part of application No. 18/560,720, filed on May 16, 2022.

(30) Foreign Application Priority Data
May 17, 2021 (DK) PA202100510

(51) Int. Cl. H04W 4/80

(52) U.S. Cl. CPC H04W 4/80

(57) ABSTRACT

A system and method for controlling operation of a device using a mobile device are disclosed. A mobile device determines a geographic location and communicates location information to a management component, which identifies candidate devices associated with locations near the geographic location. The mobile device establishes short-range wireless communication with a selected device and receives a sequence value associated with the device. The mobile device transmits a request to the management component for an activation payload including the device identifier and the sequence value. The management component generates the activation payload and transmits the activation payload to the mobile device. The mobile device transmits the activation payload to the device via the short-range wireless communication link. The device validates the activation payload and performs an operation when the activation payload is successfully validated.

### CROSS-REFERENCE TO RELATED APPLICATIONS

This application is a continuation-in-part of U.S. Application No. 18/560,720, filed November 14, 2023, which is a national stage application under 35 U.S.C. 371 of International Application No. PCT/EP2022/063191, filed May 16, 2022, which claims priority to Danish Patent Application No. PA 2021 00510, filed May 17, 2021. U.S. Application No. 18/560,720 is hereby incorporated by reference in its entirety

### TECHNICAL FIELD OF THE INVENTION

The present disclosure relates generally to systems for controlling operation of network-connected devices. More particularly, the disclosure relates to systems in which a mobile device interacts with a remote management component and nearby devices using location information and short-range wireless communication in order to securely activate the devices.

### BACKGROUND OF THE INVENTION

In many environments, users interact with shared or publicly accessible devices using mobile applications. Examples of such devices include laundry machines, vending machines, charging stations, access-controlled doors, and other service devices. These devices are often connected to remote management systems that monitor availability, process payments, and control device activation.

Mobile applications can provide convenient interfaces through which users discover available devices, initiate transactions, and activate devices. However, several technical challenges arise when coordinating interactions between mobile devices, remote management systems, and the devices themselves.

One challenge relates to device discovery. A mobile application may need to determine which devices are available in the user’s vicinity. While location-based services such as GPS can identify nearby facilities, they typically cannot confirm whether the user is physically near a particular device. Conversely, short-range wireless communication technologies such as Bluetooth Low Energy (BLE) can identify nearby devices, but do not inherently provide information about device availability, ownership, or authorization status.

Another challenge relates to security and reliability when activating devices. In many systems, activation commands are transmitted from a mobile application to a device after a transaction has been authorized by a remote server. However, simple activation commands can be vulnerable to replay attacks, spoofing, or unauthorized reuse if appropriate safeguards are not implemented.

There is therefore a need for improved systems that allow a mobile device to discover nearby devices, confirm proximity to a specific device, and securely activate that device following authorization by a remote management system.

### SUMMARY OF THE INVENTION

The present disclosure relates to systems and methods for controlling operation of devices using a mobile device in communication with a remote management component and a device capable of performing an operation. The system enables a user to discover devices located near the user, authorize operation of a selected device, and securely activate the device using a coordinated interaction between the mobile device, the management component, and the device.

In some embodiments, a mobile device determines a geographic location of the mobile device and communicates location information to a management component. The management component may identify one or more candidate devices associated with locations near the geographic location and may transmit information identifying the candidate devices to the mobile device. The mobile device may present the candidate devices to the user and may establish short-range wireless communication with a selected device.

The device may transmit a sequence value associated with the device to the mobile device. The mobile device may transmit a request to the management component for activation data associated with the device, the request including an identifier of the device and the sequence value. The management component may generate activation data associated with the device and transmit the activation data to the mobile device.

The mobile device may transmit the activation data to the device via short-range wireless communication. The device may validate the activation data and perform an operation when the activation data is successfully validated.

In certain embodiments, the activation data may incorporate the sequence value associated with the device in order to prevent reuse of activation data generated for previous activation operations. In some implementations the activation data may include a cryptographically generated payload or may include a validity period defining a time interval during which the activation data remains valid.

Through the use of location-based device discovery, proximity-based communication, and activation data generated by the management component, the system allows devices to be activated in a controlled and secure manner while reducing the risk of unauthorized activation.

### BRIEF DESCRIPTION OF THE FIGURES

FIGS. 1A-1C illustrate an example operational workflow for discovering, authorizing, and activating a device using a mobile device, a management component, and short-range wireless communication with the device.

FIG. 2 illustrates an example system architecture showing communication relationships between a mobile device, a management component, and one or more devices configured to perform operations in response to activation commands.

### DETAILED DESCRIPTION OF THE INVENTION

### Introduction

The following description sets forth example embodiments of systems and methods for controlling operation of devices using a mobile device in communication with a remote management component and the devices themselves. The disclosure particularly relates to environments in which devices are made available to users through a mobile application and may be activated following authorization of a transaction or other user request.

The systems described herein allow a user to identify devices located near the user, establish proximity-based communication with a selected device, and securely activate the device following validation by a remote management component. The described architecture combines location-based device discovery, short-range wireless communication, and server-generated activation data in order to provide a reliable and secure activation mechanism.

Although several embodiments described herein relate to service machines such as laundry machines, the systems and methods described in this disclosure are not limited to such machines. The same architecture may be used with a wide variety of devices, including vending machines, charging stations, access control devices, shared appliances, or other electronically controllable devices that may be activated by a mobile device.

### Definitions of Technical Components

### Mobile Device

In the context of the present disclosure, the term mobile device refers to an electronic device capable of executing software instructions and communicating with both remote network services and nearby devices. The mobile device may be implemented as a smartphone, tablet computer, wearable device, handheld computing device, or another portable electronic device capable of wireless communication.

The mobile device may include a processor, memory, and one or more communication interfaces. The processor may execute application software configured to interact with a management component and with nearby devices. The memory may store program instructions, device identifiers, configuration parameters, and data received from the management component.

The communication interfaces of the mobile device may include both long-range communication interfaces and short-range communication interfaces. Long-range communication interfaces may include cellular communication interfaces, Wi-Fi interfaces, or other network communication modules enabling communication with remote computing systems over one or more networks. Short-range communication interfaces may include Bluetooth Low Energy interfaces, Near Field Communication interfaces, ultra-wideband interfaces, or other wireless communication technologies enabling communication with devices located in physical proximity to the mobile device.

In certain embodiments, the mobile device executes an application that allows a user to discover nearby devices, view information associated with those devices, initiate transactions associated with the devices, and activate the devices. The mobile device may present user interface elements enabling the user to select a device and initiate an operation associated with that device.

The mobile device may further function as an intermediary between a remote management component and a device located near the mobile device. In such embodiments, the mobile device may receive information from the management component via a network and subsequently transmit that information to the device using short-range wireless communication.

### Device

The term device refers to an electronically controllable unit capable of performing an operation in response to an activation command. The device may include a control unit configured to control operation of the device and to communicate with other system components.

The control unit of the device may include a processor or microcontroller configured to execute program instructions stored in memory. The memory may store operational parameters, device identifiers, communication protocols, and other information used during operation of the device.

The device may further include a communication interface configured to enable communication with nearby mobile devices. In certain embodiments, the communication interface may support Bluetooth Low Energy communication. In other embodiments, the communication interface may support other short-range wireless communication technologies such as Near Field Communication, Wi-Fi direct communication, ultra-wideband communication, or other proximity-based communication technologies.

The device may be configured to transmit a signal that allows nearby mobile devices to detect the presence of the device. In some embodiments, the signal may include a device identifier that uniquely identifies the device. The device identifier may be transmitted periodically or in response to a communication initiated by a mobile device.

The device may be configured to receive activation data from a mobile device and to perform an operation when the activation data is validated. Validation of the activation data may involve verifying that the activation data corresponds to parameters maintained by the device, such as a sequence value associated with the device.

Devices that may be controlled using the system described in the present disclosure may include service machines such as laundry machines, vending machines, charging stations, access control devices, shared appliances, and other electronically controllable equipment.

### Management Component

The term management component refers to a computing system configured to coordinate communication between mobile devices and devices and to manage information associated with device operation.

The management component may be implemented using one or more server systems, cloud computing systems, or distributed computing systems. The management component may include one or more processors, memory resources, and communication interfaces enabling communication with mobile devices via one or more networks.

The management component may store information associated with devices deployed within the system. Such information may include device identifiers, location information associated with each device, operational status information, configuration data, and transaction records associated with device usage.

In certain embodiments, the management component may process requests from mobile devices seeking information about devices located near a particular geographic location. The management component may determine which devices are associated with the requested location and may transmit information identifying candidate devices to the mobile device.

The management component may further generate activation data used to authorize activation of devices. The activation data may be generated based on information received from the mobile device and may incorporate information associated with the device, such as device identifiers or sequence values associated with the device.

In certain embodiments, the management component may also perform transaction processing functions. For example, the management component may confirm that payment has been authorized before activation data is generated for a device.

### Geographic Location

The term geographic location refers to information representing the physical location of a mobile device. The geographic location may be determined using a positioning system such as the Global Positioning System or another satellite-based positioning system.

In some embodiments, geographic location information may also be determined using network-based positioning techniques. Such techniques may include Wi-Fi positioning systems, cellular network triangulation, or other techniques capable of estimating the position of the mobile device based on signals received from surrounding network infrastructure.

In certain embodiments, geographic location information may be determined using information provided by a user. For example, the mobile device may allow a user to enter an address associated with a facility containing one or more devices. The entered address may be used to determine a location associated with the facility and to identify devices located at that facility.

The geographic location may be used by the management component to identify devices associated with locations near the mobile device.

### Candidate Devices

The term candidate devices refers to devices identified by the management component as potentially available for interaction by a mobile device based on the geographic location of the mobile device.

Candidate devices may correspond to devices located within a facility associated with the geographic location or within a predetermined distance of the geographic location. The management component may maintain a mapping between device identifiers and physical locations in order to identify candidate devices.

In some embodiments, candidate devices may be ranked or sorted according to proximity to the geographic location of the mobile device. Other ranking criteria may also be used, such as device availability, operational status, or historical usage information.

Information identifying candidate devices may be transmitted from the management component to the mobile device. The mobile device may present candidate devices to the user through a user interface.

In certain embodiments, the information identifying candidate devices includes one or more device identifiers, location identifiers, or other information sufficient for the mobile device to present the candidate devices for selection and to associate a selected candidate device with short-range wireless detection.

### Short-Range Wireless Communication

The term short-range wireless communication refers to wireless communication technologies capable of exchanging data between devices located within relatively close physical proximity.

Examples of short-range wireless communication technologies include Bluetooth Low Energy communication, Near Field Communication, ultra-wideband communication, and other wireless technologies designed for communication between nearby devices.

Short-range wireless communication may allow a mobile device to establish communication with a device only when the mobile device is located near the device. This proximity requirement may be used to ensure that device activation occurs only when the user is physically near the device.

In certain embodiments, the mobile device may initiate short-range communication by scanning for wireless signals transmitted by nearby devices. In other embodiments, the device may initiate communication in response to a connection request transmitted by the mobile device.

### Sequence Value

The term sequence value refers to a value associated with a device that may change between successive activation operations.

The sequence value may be generated or maintained by the device and may be transmitted to the mobile device during short-range communication. The sequence value may represent a counter, token, or other value that changes in a predictable or controlled manner.

In some embodiments, the sequence value may be incremented after each activation operation performed by the device. In other embodiments, the sequence value may be generated using a pseudorandom sequence or another mechanism capable of producing values that change between activation operations.

The sequence value may be used in generating an activation payload associated with the device. By incorporating the sequence value into the activation payload, the system may prevent reuse of the activation payload generated for a previous activation operation.

The sequence value may be numeric, alphanumeric, or otherwise encoded.

In certain embodiments, the sequence value represents device state information that is expected to differ between successive activation operations. By requiring the activation payload to be generated using the device state information and by requiring the device to validate consistency with its current state information, previously generated activation payloads become invalid when the device state changes.

### Activation Data

The term activation data refers to data generated by the management component and transmitted to a device in order to authorize the device to perform an operation.

Activation data may be generated based on information received from the mobile device. Such information may include an identifier associated with the device and a sequence value associated with the device. In certain embodiments, the activation data may also incorporate transaction information or other contextual information.

Activation data may be transmitted from the management component to the mobile device via a network connection. The mobile device may subsequently transmit the activation data to the device via short-range wireless communication.

The device may validate the activation data before performing the operation associated with the activation request. Validation may involve verifying that the activation data corresponds to parameters associated with the device, such as the sequence value maintained by the device.

In certain embodiments, the activation data may be generated using a deterministic function that combines the device identifier, the sequence value, and optionally one or more additional parameters such as a transaction identifier, timestamp, or cryptographic key associated with the management component. The resulting activation payload may therefore be uniquely associated with a specific activation request and device state.

### Activation Payload

The term activation payload refers to a form of activation data generated by the management component that contains information required to activate the device.

The activation payload may include one or more data fields containing information associated with the activation request. In some embodiments, the activation payload may include a device identifier, a sequence value, and other information used by the device to validate the activation request.

In certain embodiments, the activation payload may be generated using cryptographic techniques. For example, the activation payload may include a cryptographically generated token, a digitally signed message, or encrypted activation information.

In certain embodiments, the token may be generated using a cryptographic function applied to the device identifier, the sequence value, and a secret key associated with the management component.

The activation payload may also include a validity period defining a time interval during which the activation payload remains valid. If the activation payload is not used within the validity period, the device may reject the activation payload.

### Activation Protocol

### Overview of Device Activation Process

In some embodiments, activation of a device is performed using a coordinated protocol involving a mobile device, a management component, and the device itself. The protocol allows a device to be activated only after a sequence of interactions that establish device proximity, obtain device-specific information, and generate an activation payload based on that information.

In certain embodiments, the principal security mechanism of the system is a protocol in which a device-provided sequence value obtained over a short-range wireless link is used by the management component to generate an activation payload that is returned to the mobile device and relayed to the device for validation and execution.

The activation process may begin when a user selects a device using an application executing on the mobile device. The application may present candidate devices that have been identified based on the geographic location of the mobile device. After a device is selected, the mobile device may establish short-range wireless communication with the selected device.

The device may then transmit a sequence value associated with the device to the mobile device. The sequence value may represent the current activation state of the device or may represent a value used to ensure uniqueness of activation requests.

The mobile device may transmit a request to the management component seeking an activation payload for the selected device. The request may include at least the identifier of the device and the sequence value received from the device. In certain embodiments, the request may further include information associated with a transaction authorized by the user.

The management component may generate the activation payload based on the information received in the request. The generated activation payload may be transmitted to the mobile device.

The mobile device may then relay the activation payload to the device using short-range wireless communication. The device may validate the received activation payload and, if validation is successful, may perform the operation associated with the activation request.

### Interaction Between Mobile Device and Device

In certain embodiments, the activation process includes a direct interaction between the mobile device and the device using short-range wireless communication.

The mobile device may initiate communication by scanning for short-range wireless signals transmitted by nearby devices. When a device is detected, the mobile device may establish a communication session with the device.

During the communication session, the device may transmit information identifying the device as well as the sequence value associated with the device. The sequence value may represent a value maintained by the device that changes between activation operations.

The mobile device may store the sequence value received from the device and may include the sequence value in a request transmitted to the management component. In this way, the sequence value obtained directly from the device may be incorporated into the activation data generated by the management component.

In some embodiments, the device may update the sequence value after an activation operation has been successfully completed. Updating the sequence value may ensure that an activation payload generated for a previous activation operation cannot be reused for subsequent operations.

In certain embodiments, the sequence value used to request the activation payload is received from the device via the short-range wireless communication link immediately prior to generation of the activation payload by the management component. This ties the activation payload to both the current state of the device and the physical proximity of the mobile device to the device.

### Interaction Between Mobile Device and Management Component

Following receipt of the sequence value from the device, the mobile device may transmit a request to the management component.

The request may include an identifier associated with the device and the sequence value obtained from the device. The request may also include other information associated with the activation request. For example, the request may include a transaction identifier associated with a transaction authorized by the user for use of the device.

The management component may process the request to determine whether activation of the device should be authorized. In certain embodiments, the management component may verify that the device identifier corresponds to a device known to the management component and may verify that any required transaction authorization has been completed.

The management component may then generate an activation payload associated with the device. The activation payload may be generated based on the information contained in the request received from the mobile device. For example, the activation payload may be generated using the device identifier and the sequence value.

The activation payload may be transmitted from the management component to the mobile device through the network connection between the mobile device and the management component.

In some embodiments, the request may further include a transaction identifier associated with a previously authorized payment transaction or other authorization event associated with operation of the device.

In certain embodiments, the management component generates and transmits the activation payload only after determining that a transaction associated with operation of the device has been successfully authorized. If the transaction is not successfully authorized, the management component may refrain from generating or transmitting the activation payload.

### Relay of the Activation Payload to the Device

After receiving the activation payload from the management component, the mobile device may transmit the activation payload to the device using the short-range wireless communication interface.

In this configuration, the mobile device acts as an intermediary that relays an activation payload from the management component to the device. The device itself may not require a direct network connection to the management component.

The activation payload may contain the information necessary for the device to validate the activation request.

In some embodiments, the activation payload may contain information derived from the device identifier and the sequence value. In certain embodiments, the activation payload may also contain transaction-related information or other parameters associated with the activation request.

In certain embodiments, the device is configured to perform the requested operation only when the activation payload is received via the short-range wireless communication interface, thereby ensuring that activation occurs only when a mobile device is physically located near the device.

### Validation of an Activation Payload by the Device

Upon receiving an activation payload from the mobile device, the device may validate the activation payload before performing the requested operation.

Validation of the activation payload may include verifying that the activation payload corresponds to the sequence value currently maintained by the device. If the sequence value contained in the activation payload does not match the sequence value expected by the device, the device may reject the activation payload.

In certain embodiments, validation may also involve verifying additional parameters contained in the activation payload. For example, the device may verify that the activation payload has not expired or that the activation payload has been generated for the correct device identifier.

If validation of the activation payload is successful, the device may perform the operation associated with the activation request.

### Completion of Device Operation

After successful validation of the activation payload, the device may perform the operation requested by the user. The operation performed by the device may depend on the type of device.

For example, in embodiments where the device corresponds to a service machine, the device may initiate operation of the machine. In embodiments where the device corresponds to an access control system, the device may unlock a door or grant access to a controlled area.

Following completion of the activation operation, the device may update the sequence value associated with the device. Updating the sequence value may ensure that activation data generated for the completed operation cannot be reused.

The updated sequence value may be used during subsequent activation operations involving the device.

### Security Characteristics of the Activation Protocol

The activation protocol described herein provides several security advantages. Because the activation payload generated by the management component incorporates the sequence value obtained directly from the device, the activation payload generated for a previous activation operation cannot be reused once the sequence value has been updated.

Furthermore, because the activation payload is relayed to the device through the mobile device using short-range wireless communication, activation of the device may require physical proximity between the mobile device and the device.

In certain embodiments, the activation payload may include cryptographically generated information that allows the device to verify that the activation payload was generated by the management component. Such mechanisms may further enhance the security of the activation protocol.

The operations described herein are rooted in computer and wireless communication technology and, in particular, in the generation, transmission, and validation of the activation payload across heterogeneous communication links, including a network link between the mobile device and management component and a short-range wireless link between the mobile device and the device. The described protocol coordinates these links to achieve secure device activation based on device state information, rather than merely organizing human activity.

Accordingly, the disclosed techniques improve computer and wireless communication functionality by providing a secure activation protocol that leverages device state information and coordinated transmission over heterogeneous links to control operation of networked devices.

### Authorized Device Identification

In certain embodiments, the system may employ an authorization mechanism that allows a mobile device to identify devices that are eligible for interaction prior to initiating an activation sequence. This mechanism may be used in addition to, or independently of, the location-based discovery techniques described above.

In such embodiments, the management component may transmit information identifying one or more authorized devices to the mobile device. The information may include identifiers associated with devices that are approved for interaction by the mobile device. The identifiers may correspond to devices associated with a particular facility, location, or service provider.

The identifiers may be transmitted to the mobile device in response to a request from the mobile device. For example, after determining the geographic location of the mobile device, the mobile device may transmit location information to the management component. The management component may then determine which devices are associated with locations near the mobile device and may transmit identifiers associated with those devices to the mobile device.

The mobile device may store the received identifiers locally. When the mobile device detects wireless signals transmitted by nearby devices, the mobile device may compare identifiers obtained from the detected signals with the identifiers received from the management component. Devices whose identifiers correspond to the stored identifiers may be treated as authorized devices eligible for interaction by the mobile device.

This approach may allow the mobile device to distinguish devices associated with the system from unrelated wireless devices that may be present in the surrounding environment. For example, in environments such as residential buildings or shared facilities, multiple wireless devices may transmit signals that can be detected by the mobile device. By comparing detected identifiers with a set of authorized identifiers obtained from the management component, the mobile device may identify which devices are associated with the system.

In certain embodiments, the mobile device may perform such comparisons locally without transmitting identifiers associated with all detected wireless signals to the management component. Local comparison of identifiers may reduce communication between the mobile device and the management component and may allow the mobile device to quickly determine whether a detected device is eligible for interaction.

The authorized device identification mechanism described in this section may be used in combination with the activation protocol described above. For example, the mobile device may first determine whether a detected device corresponds to an authorized device identifier before initiating the activation protocol. However, the activation protocol may also be implemented independently of the authorized device identification mechanism described in this section.

In some embodiments, the identifiers associated with authorized devices may be transmitted to the mobile device in advance and stored locally so that the mobile device may compare detected wireless identifiers with the stored identifiers without contacting the management component.

### Example Operational Scenario

The illustrated sequence is exemplary, and in other embodiments one or more steps may be reordered, combined, performed in parallel, or omitted.

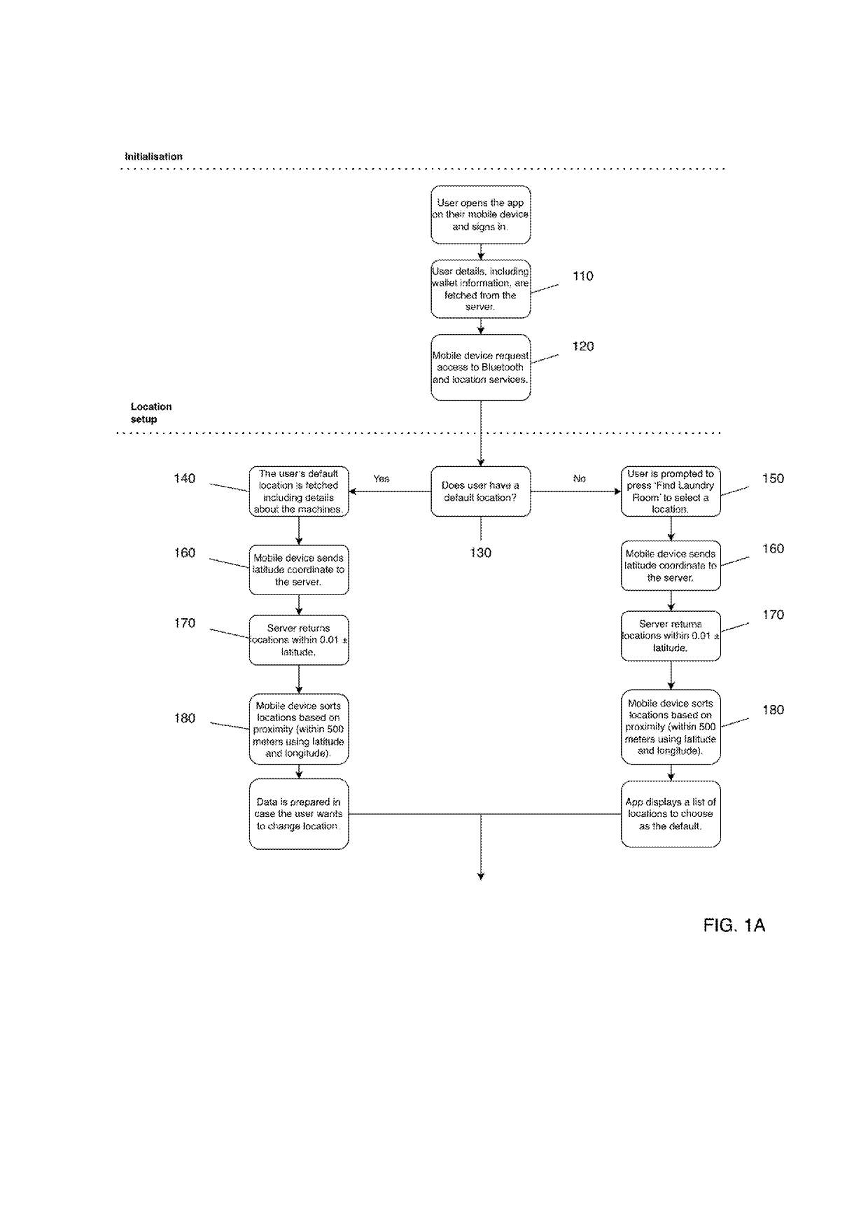

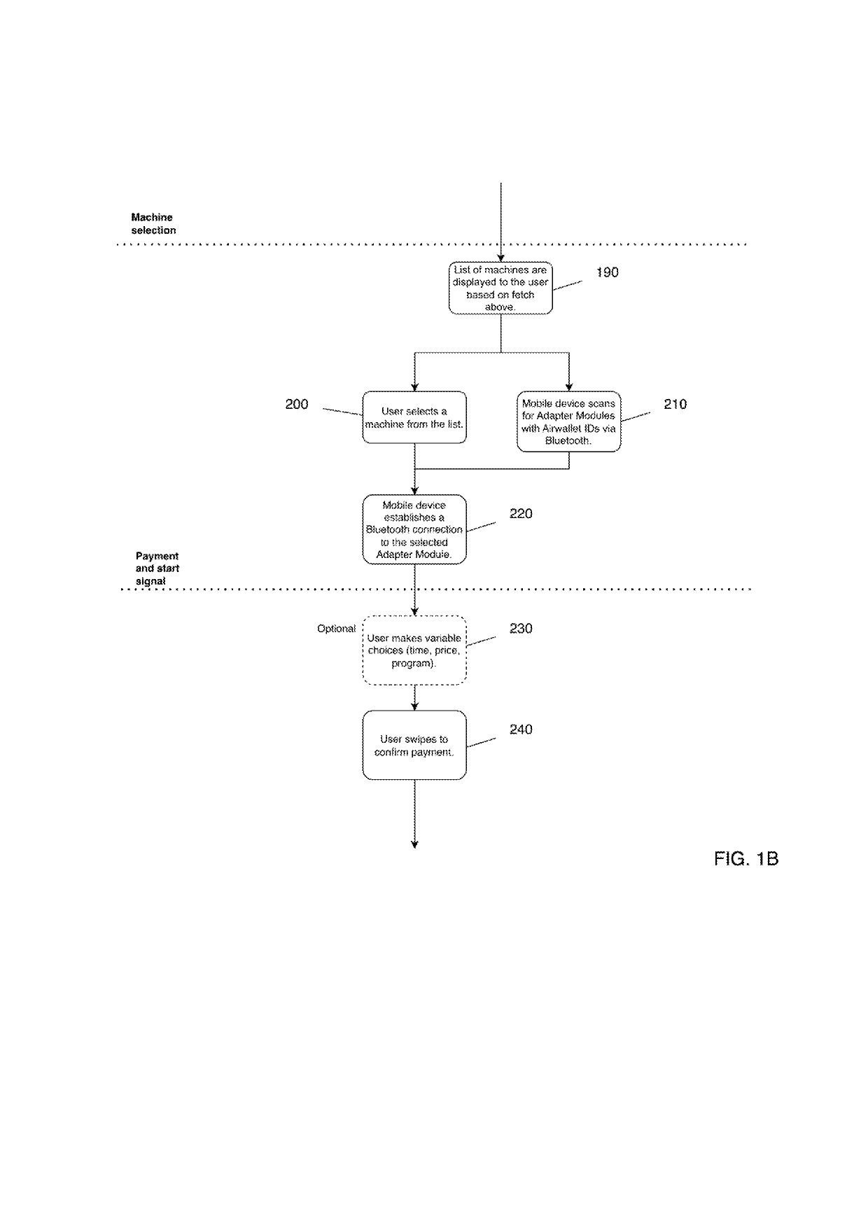

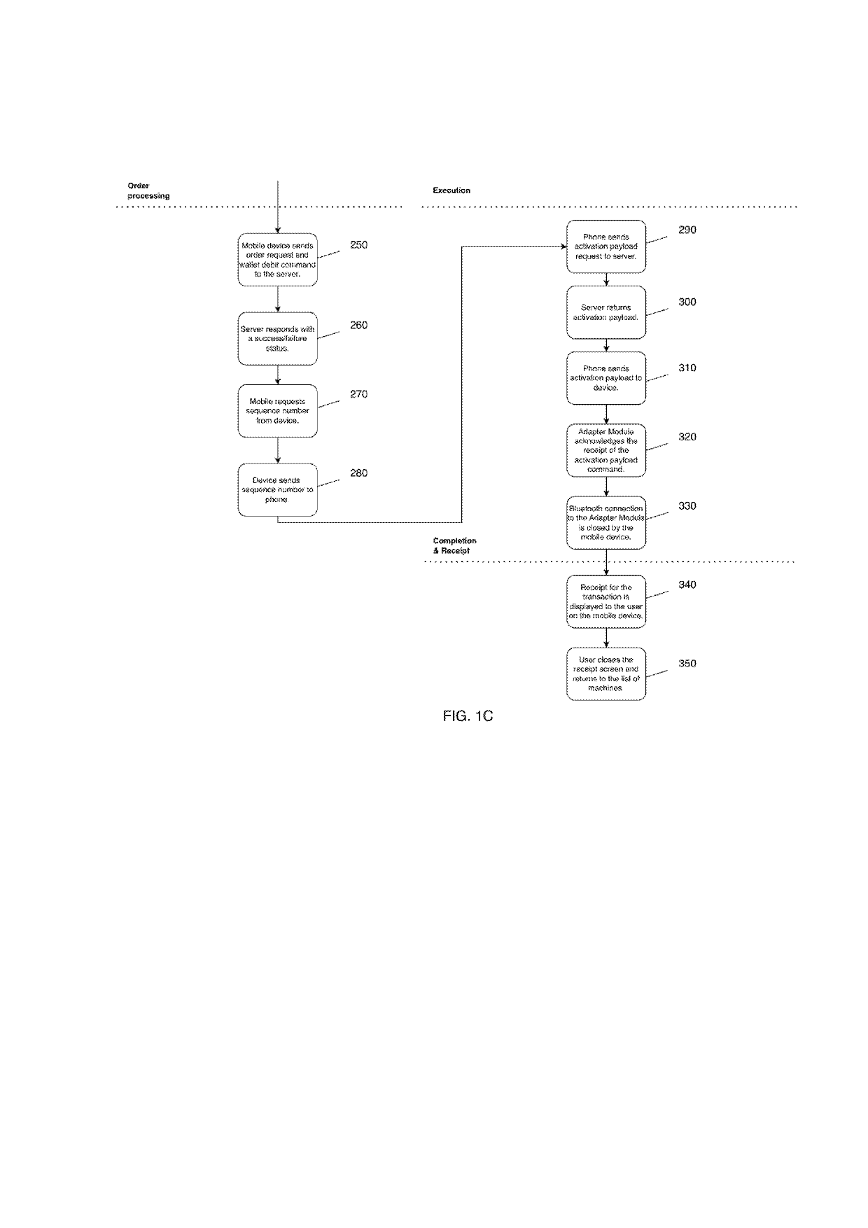

An example operational scenario illustrating interaction between the mobile device, the management component, and the device is shown in FIGS. 1A-1C. The figures collectively illustrate one example workflow through which a user may discover, authorize, and activate a device using the system described in this disclosure. Each block in the figures corresponds to a step in the operational process and is identified using a reference numeral.

The operational process may begin with initialization of an application executing on the mobile device. As illustrated in step 100 of FIG. 1A, a user opens the application on the mobile device and signs in to the system. Following authentication, the mobile device may retrieve information associated with the user account from the management component, including user details and wallet information associated with the account, as shown in step 110.

During initialization, the mobile device may request permission to access certain device capabilities such as Bluetooth communication and location services. This request is illustrated in step 120. Access to these capabilities allows the mobile device to determine the geographic location of the device and to communicate with nearby devices using short-range wireless communication technologies.

The application may then determine whether a default location has been configured for the user, as illustrated in decision step 130. If a default location exists, the mobile device may retrieve information associated with that location, including details about devices located at the facility corresponding to the default location, as shown in step 140. If no default location is defined, the user may be prompted to select or define a location associated with the desired devices, as illustrated in step 150.

After a location has been determined, the mobile device may transmit location information to the management component. In one embodiment, the mobile device transmits geographic information such as latitude information to the management component, as illustrated in step 160. The management component may process the received information and may identify locations associated with the provided geographic information. For example, the management component may identify facilities located within a predetermined geographic range, as illustrated in step 170.

The mobile device may then sort or prioritize the returned locations according to proximity to the mobile device. This operation is illustrated in step 180. Locations may be ranked based on calculated distances derived from latitude and longitude coordinates or other location metrics.

Once a location has been selected, the mobile device may retrieve and display a list of devices associated with that location. As illustrated in step 190 of FIG. 1B, the application may display a list of available machines or devices associated with the selected location.

The user may select a device from the list, as illustrated in step 200. After a device has been selected, the mobile device may begin scanning for short-range wireless signals transmitted by nearby devices, as shown in step 210. In certain embodiments, the mobile device scans for Bluetooth signals transmitted by adapter modules associated with the devices.

When a Bluetooth signal corresponding to the selected device is detected, the mobile device may establish a Bluetooth communication connection with the adapter module, as illustrated in step 220.

In some embodiments, the user may configure parameters associated with operation of the device before activation occurs. For example, the user may select configuration options such as a program type, a time duration, or other operational parameters associated with the device. This configuration stage is illustrated in optional step 230.

Once the user confirms the desired configuration, the user may authorize payment for operation of the device. For example, the user may perform a swipe gesture or another confirmation action within the application, as illustrated in step 240.

Following confirmation of payment, the mobile device may transmit an order request to the management component, as illustrated in step 250 of FIG. 1C. The order request may include information identifying the selected device and may include instructions to debit the user's wallet or payment account.

The management component may process the order request and may determine whether the transaction is authorized. The management component may then transmit a response to the mobile device indicating whether the transaction has been successfully authorized, as illustrated in step 260.

Following authorization of the transaction, the mobile device may request a sequence value from the device, as illustrated in step 270. The device may transmit the sequence value to the mobile device via the short-range wireless communication link, as illustrated in step 280.

The mobile device may then transmit a request to the management component seeking an activation payload associated with the device. This request is illustrated in step 290. The request may include the identifier of the device and the sequence value received from the device.

The management component may generate an activation payload associated with the device and may transmit the activation payload to the mobile device, as illustrated in step 300.

The mobile device may then transmit the activation payload to the device via the short-range wireless communication connection, as illustrated in step 310.

Upon receiving the activation payload, the device may acknowledge receipt of the activation payload command, as illustrated in step 320, and may validate the activation payload using parameters maintained by the device.

If the validation is successful, the device may begin performing the requested operation. Following successful activation, the short-range wireless communication connection between the mobile device and the device may be closed, as illustrated in step 330.

After completion of the activation process, a receipt associated with the transaction may be displayed to the user on the mobile device, as illustrated in step 340. The user may then close the receipt screen and return to the list of available devices within the application.

### System Architecture

### Overview of System Components

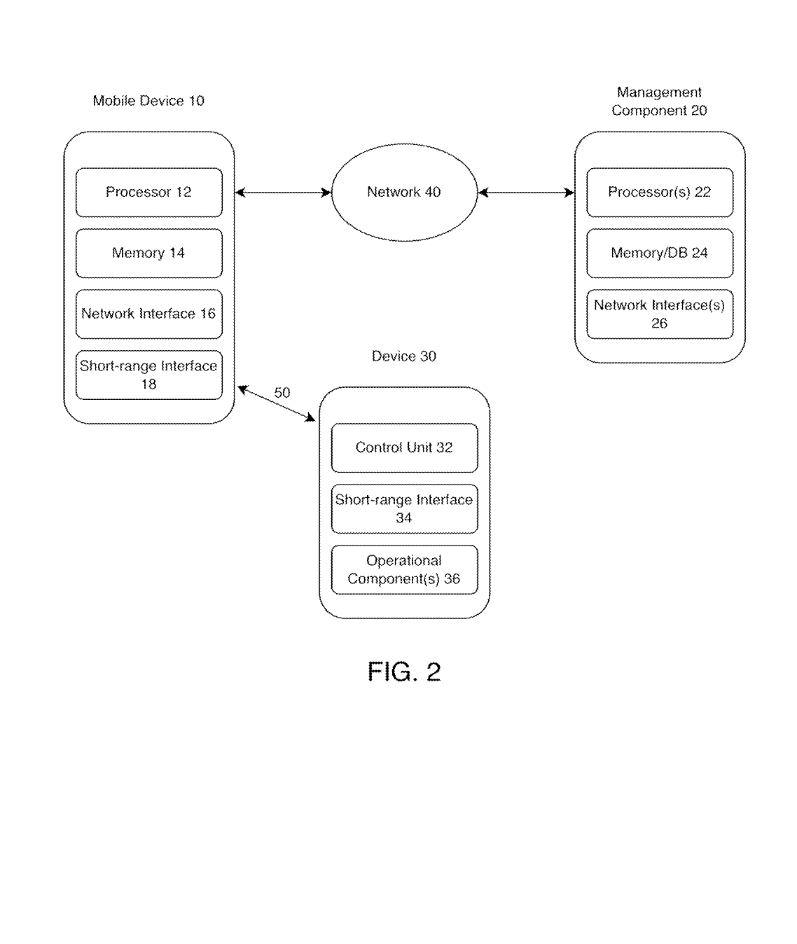

An example system architecture implementing the techniques described in this disclosure is illustrated in FIG. 2. The system may include a mobile device 10, a management component 20, and one or more devices 30 configured to perform operations in response to activation commands.

The mobile device 10 may communicate with the management component 20 through a communication network 40. The communication network 40 may include one or more wireless communication networks, such as cellular communication networks, wireless local area networks, or other data communication networks capable of transmitting data between computing devices.

The mobile device 10 may also communicate with the device 30 using a short-range wireless communication interface 50. In certain embodiments, the short-range wireless communication interface may implement Bluetooth Low Energy communication. However, other short-range communication technologies may be used, including Near Field Communication, ultra-wideband communication, or other proximity-based communication technologies.

Through this architecture, the mobile device 10 may function as an intermediary that relays information between the management component 20 and the device 30. For example, the activation payload generated by the management component 20 may be transmitted to the mobile device 10 through the communication network 40 and subsequently relayed to the device 30 through the short-range wireless communication interface 50.

### Mobile Device Architecture

The mobile device 10 may include a processor 12, a memory 14, and one or more communication interfaces enabling communication with both remote systems and nearby devices.

The processor 12 may execute instructions associated with an application configured to allow a user to interact with the system. The application may allow the user to discover devices located near the user, select a device for operation, authorize payment associated with device operation, and activate the selected device.

The memory 14 may store instructions executed by the processor 12 as well as data associated with the application. For example, the memory may store user account information, device identifiers, configuration parameters, and information received from the management component.

The mobile device 10 may further include a network communication interface 16 enabling communication with the management component 20 via the communication network 40. The mobile device may also include a short-range communication interface 18 configured to communicate with nearby devices.

The short-range communication interface 18 may allow the mobile device to detect signals transmitted by nearby devices and to establish a communication session with a selected device.

### Management Component Architecture

The management component 20 may be implemented as one or more server systems configured to manage information associated with devices and to coordinate communication between mobile devices and devices.

The management component 20 may include one or more processors 22, memory resources 24, and network communication interfaces 26 enabling communication with mobile devices through the communication network 40.

The memory resources 24 may store information associated with devices deployed within the system. Such information may include device identifiers, device location information, operational status information, configuration data, and transaction records associated with device usage.

The management component 20 may process requests transmitted by mobile devices seeking information about devices located near a particular geographic location. The management component may also generate the activation payload associated with devices and transmit such an activation payload to mobile devices following authorization of device operations.

In certain embodiments, the management component 20 may further perform payment processing or transaction authorization functions associated with activation of devices.

### Device Architecture

The device 30 may correspond to any electronically controllable unit capable of performing an operation when activated. The device may include a control unit 32, a communication interface 34, and one or more operational components 36 responsible for performing the operation associated with the device.

The control unit 32 may include a processor or microcontroller configured to control operation of the device and to execute instructions stored in memory associated with the device.

The communication interface 34 may allow the device to communicate with nearby mobile devices using short-range wireless communication. In certain embodiments, the communication interface may be implemented using Bluetooth Low Energy communication. The communication interface may allow the device to transmit device identifiers, sequence values, and other information to mobile devices.

The device 30 may maintain a sequence value associated with activation operations. The sequence value may be transmitted to the mobile device when short-range communication is established.

The control unit 32 may further be configured to receive an activation payload transmitted by the mobile device. Upon receiving an activation payload, the control unit may validate the activation payload using parameters associated with the device. If the activation payload is successfully validated, the control unit 32 may activate the operational components 36 to perform the requested operation.

The operational components 36 may vary depending on the type of device. For example, in certain embodiments, the device may correspond to a service machine such as a laundry machine. In such embodiments, the operational components may include motors, valves, heating elements, or other components associated with operation of the service machine.

### Communication Relationships

The architecture illustrated in FIG. 2 enables coordinated communication between the mobile device 10, the management component 20, and the device 30.

The mobile device 10 communicates with the management component 20 via the communication network 40 in order to obtain information about candidate devices, authorize transactions, and request an activation payload associated with a device.

The mobile device 10 communicates with the device 30 via the short-range wireless communication interface 50 in order to detect nearby devices, obtain device-specific information such as sequence values, and transmit an activation payload generated by the management component.

Because the device 30 communicates with the management component 20 indirectly through the mobile device 10, the device may not require a direct network connection to the management component. This architecture may simplify deployment of devices in environments where network connectivity may be limited or unavailable.

The allocation of functionality between the mobile device, the management component, and the device provides a distributed architecture in which device state information is obtained locally via short-range communication while authorization data is generated remotely based on that state information. This division of roles improves security and reliability relative to systems that rely solely on static device identifiers or reusable activation commands.

### Security and Replay Protection Mechanisms

In certain embodiments, the activation protocol described in this disclosure incorporates security mechanisms that prevent unauthorized activation of devices and reduce the risk of replay attacks or other misuse of activation commands.

One security mechanism implemented in the system involves the use of the sequence value maintained by the device. As described above, the device may maintain a sequence value that changes between successive activation operations. The sequence value may be transmitted from the device to the mobile device when short-range communication is established.

The mobile device may include the sequence value in a request transmitted to the management component when requesting an activation payload associated with the device. Because the sequence value originates from the device itself, the activation payload generated by the management component may be tied to the current operational state of the device.

When the management component generates an activation payload, the activation payload may incorporate the sequence value received from the device. The resulting activation payload may therefore be associated with a specific activation attempt corresponding to the sequence value provided by the device.

Upon receiving the activation payload from the mobile device, the device may validate the activation payload by verifying that the activation payload corresponds to the sequence value currently maintained by the device. If the sequence value contained in the activation payload does not correspond to the sequence value expected by the device, the activation payload may be rejected.

In certain embodiments, the device may update the sequence value after a successful activation operation. Because the sequence value changes after each activation, the activation payload generated for a previous activation attempt cannot be reused once the sequence value has been updated.

This mechanism may reduce the risk that an activation payload intercepted during a previous activation operation could be reused to activate the device at a later time.

In some embodiments, additional security mechanisms may also be implemented. For example, the activation payload generated by the management component may include cryptographically generated information such as a signed token or encrypted data structure. The device may verify the authenticity of the activation payload before performing the requested operation.

For example, the device may verify a digital signature using a stored public key, verify a message authentication code using a shared secret, and/or decrypt an encrypted payload using a device-specific key.

In certain embodiments, the activation payload may further include a validity period defining a time interval during which the activation payload remains valid. The device may verify that the activation payload has not expired before performing the requested operation.

Through the use of sequence values, validation procedures, and optional cryptographic mechanisms, the activation protocol may ensure that device activation occurs only when authorized by the management component and when the mobile device is physically present near the device.

In this manner, the disclosed techniques improve the security of device activation in a networked environment by coupling a server-generated activation payload to a device-maintained sequence value and enforcing proximity-based delivery of the activation payload. This reduces susceptibility to replay of prior activation messages and reduces unauthorized remote activation attempts. In addition, because activation is completed via short-range communication using an activation payload generated in response to a specific request, the system reduces unnecessary network communication and enables reliable activation even when the device lacks direct connectivity to the management component.

As used in the specification and the appended claims, the singular forms "a", "an", and "the" include plural referents unless the context clearly dictates otherwise. Ranges may be expressed herein as from "about" or "approximately" one particular value and/or to "about" or "approximately" another particular value. When such a range is expressed, another embodiment includes from the one particular value and/or to the other particular value. Similarly, when values are expressed as approximations, by use of the antecedent "about", it will be understood that the particular value forms another embodiment.

It should be noted that embodiments and features described in the context of one of the aspects of the present invention also apply to the other aspects of the invention.

1. A system for controlling operation of a device, the system comprising:
a mobile device;
a device configured to perform an operation; and
a management component communicatively coupled to the mobile device via a network,
wherein the mobile device is configured to:
determine a geographic location of the mobile device;
transmit location information to the management component;
receive from the management component information identifying one or more candidate devices associated with locations near the geographic location;
establish short-range wireless communication with the device;
receive from the device a sequence value associated with the device;
transmit to the management component a request for an activation payload, the
request comprising at least an identifier of the device and the sequence value;
receive from the management component an activation payload associated with the device; and
transmit the activation payload to the device via the short-range wireless communication to activate the device.

2. The system according to claim 1, wherein the geographic location is determined using a positioning system.

3. The system according to claim 1, wherein the management component ranks
the candidate devices according to proximity to the mobile device.

4. The system according to claim 1, wherein the short-range wireless communication comprises Bluetooth Low Energy communication.

5. The system according to claim 1, wherein the request transmitted to the management component further comprises a transaction identifier associated
with an authorized transaction.

6. The system according to claim 1, wherein the sequence value is generated by the device and updated for successive activation operations.

7. The system according to claim 1, wherein the activation payload is generated by the management component based on the sequence value.

8. The system according to claim 1, wherein the device validates the activation
payload before performing the operation.

9. The system according to claim 1, wherein the operation comprises initiating operation of a service machine.

10. The system according to claim 9, wherein the service machine is a laundry machine.

11. The system of claim 1, wherein the activation payload is generated by the management component using the sequence value received from the device via
the short-range wireless communication.

12. The system of claim 1, wherein the device is configured to verify the activation payload using the sequence value before performing the operation.

13. The system of claim 1, wherein the activation payload includes a validity period during which the device may be activated.

14. The system of claim 1, wherein the device performs the operation only when the activation payload is received via the short-range wireless communication
link.

15. The system of claim 1, wherein the management component ranks the candidate devices based on distance from the geographic location of the mobile device.

16. The system of claim 1, wherein the geographic location is determined using a positioning system and, if the positioning system is unavailable, based on a user- provided address.

17. The system of claim 1, wherein the management component authorizes the
activation of the device based on confirmation of a payment transaction associated with the device.

18. The system of claim 1, wherein the mobile device relays the activation payload from the management component to the device via the short-range
wireless communication link.

19. The system of claim 1, wherein the device transmits a short-range wireless signal containing a device identifier detectable by the mobile device.

20. The system of claim 1, wherein the activation payload comprises a cryptographically generated token.

21. A method for controlling operation of a device, the method comprising:
determining, by a mobile device, a geographic location of the mobile device;
transmitting location information from the mobile device to a management component;
receiving, at the mobile device from the management component, information identifying one or more candidate devices associated with locations near the geographic location;
establishing, by the mobile device, short-range wireless communication with a device;
receiving, at the mobile device from the device, a sequence value associated with the device;
transmitting, from the mobile device to the management component, a request for an activation payload, the request comprising at least an identifier of the
device and the sequence value;
receiving, at the mobile device from the management component, an activation payload associated with the device; and
transmitting, from the mobile device to the device via the short-range wireless communication, the activation payload to activate the device.

22. The method according to claim 21, wherein the geographic location is determined using a positioning system.

23. The method according to claim 21, further comprising ranking, by the
management component, the candidate devices according to proximity to the geographic location of the mobile device.

24. The method according to claim 21, wherein the short-range wireless communication comprises Bluetooth Low Energy communication.

25. The method according to claim 21, wherein the request transmitted to the management component further comprises a transaction identifier associated with an authorized transaction.

26. The method according to claim 21, wherein the sequence value is generated by the device and updated for successive activation operations.

27. The method according to claim 21, wherein the activation payload is generated by the management component based on the sequence value.

28. The method according to claim 21, further comprising validating, by the
device, the activation payload before performing the operation.

29. The method according to claim 21, wherein the operation comprises initiating operation of a service machine.

30. The method according to claim 29, wherein the service machine is a laundry machine.

31. A device configured to perform an operation, the device comprising:
a control unit; and
a short-range wireless communication interface,
wherein the control unit is configured to:
transmit a sequence value associated with the device to a mobile device via the short-range wireless communication interface;
receive an activation payload from the mobile device via the short-range wireless communication interface, the activation payload being generated by a management component based on at least the sequence value and an identifier of the device;
validate the activation payload; and
perform the operation when the activation payload is successfully validated.

32. The device according to claim 31, wherein the control unit is configured to update the sequence value for successive activation operations.

33. The device according to claim 31, wherein the activation payload is generated by the management component.

34. The device according to claim 31, wherein the device performs the operation only when the activation payload is received via the short-range wireless
communication interface.

35. The device according to claim 31, wherein the short-range wireless communication interface comprises a Bluetooth Low Energy interface.

36. The device according to claim 31, wherein the device transmits a wireless
signal containing a device identifier detectable by the mobile device.

37. The device according to claim 31, wherein the activation payload comprises a cryptographically generated token.

38. The device according to claim 31, wherein the control unit validates the activation payload using the sequence value.

39. The device according to claim 31, wherein the operation comprises initiating operation of a service machine.

40. The device according to claim 39, wherein the service machine is a laundry machine.

41. A system for controlling operation of a device, the system comprising:
a mobile device;
a device configured to perform an operation; and
a management component communicatively coupled to the mobile device via a network,
wherein the mobile device is configured to:
establish short-range wireless communication with the device;
receive, from the device via the short-range wireless communication, a sequence value associated with the device;
transmit to the management component a request for an activation payload, the request comprising at least an identifier of the device and the sequence value;
and - receive the activation payload from the management component only after
authorization of a transaction associated with the device;
wherein the management component is configured to generate the activation payload based at least in part on the sequence value and to transmit the activation payload to the mobile device following successful authorization of the
transaction; and
wherein the mobile device is configured to transmit the activation payload to the device via the short-range wireless communication, and the device is configured to validate the activation payload and perform the operation when the activation payload is successfully validated.

42. A method for controlling operation of a device, the method comprising:
establishing, by a mobile device, short-range wireless communication with the device;
receiving, at the mobile device from the device via the short-range wireless
communication, a sequence value associated with the device;
transmitting, from the mobile device to a management component, a request for an activation payload, the request comprising at least an identifier of the device and the sequence value;
authorizing, by the management component, a transaction associated with the
device;
generating, by the management component, the activation payload based at least in part on the sequence value after successful authorization of the transaction;
transmitting the activation payload from the management component to the
mobile device;
transmitting the activation payload from the mobile device to the device via the short-range wireless communication; and
validating, by the device, the activation payload and performing an operation when the activation payload is successfully validated.
